(19) United States
(12) Patent Application Publication
(10) Pub. No.: US 2026/0210707 A1
(43) Pub. Date: Jul. 23, 2026

(54) METHODS FOR MEASURING INNER PROFILE OF THIN-WALLED COMPOSITE TUBULAR COMPONENT WITH LARGE LENGTH-TO-DIAMETER RATIO

(71) Applicant: CHENGDU AIRCRAFT INDUSTRIAL (GROUP) CO., LTD., Chengdu (CN)

(72) Inventors: Zhengyang CHEN, Chengdu (CN); Li ZHANG, Chengdu (CN); Haiping NIE, Chengdu (CN); Linzhi YANG, Chengdu (CN); Hongyu CHEN, Chengdu (CN); Hao SHEN, Chengdu (CN)

(73) Assignee: CHENGDU AIRCRAFT INDUSTRIAL (GROUP) CO., LTD., Chengdu (CN)

(21) Appl. No.: 19/570,251

(22) Filed: Mar. 18, 2026

Related U.S. Application Data
(63) Continuation of application No. PCT/CN2024/100340, filed on Jun. 20, 2024.

(30) Foreign Application Priority Data
Sep. 18, 2023 (CN) 202311196915.X

(51) Int. Cl. G01B 21/04; G01B 21/08; G01B 21/20

(52) U.S. Cl. CPC G01B 21/042; G01B 21/08; G01B 21/20

(57) ABSTRACT

The present disclosure relates to a method for measuring an inner profile of a thin-walled composite tubular component with a large length-to-diameter ratio. The method includes: calibrating a fixture coordinate system; acquiring an outer profile point cloud map of a tubular component to be inspected through a scanner; measuring a thickness value of a discrete point; acquiring a normal vector of the discrete point based on the outer profile point cloud map; compensating probe coordinates of the discrete point according to the normal vector; and calculating inner profile coordinates corresponding to the discrete point according to the normal vector, the thickness value, and outer profile coordinates.

### CROSS-REFERENCE TO RELATED APPLICATIONS

This application is a Continuation of International Application No. PCT/CN2024/100340, filed on Jun. 20, 2024, which claims priority to Chinese Patent Application No. 202311196915.X, filed on Sep. 18, 2023, the entire contents of each of which are hereby incorporated by reference.

### TECHNICAL FIELD

The present disclosure relates to the field of profile inspection technology, and in particular to a method for measuring an inner profile of a thin-walled composite tubular component with a large length-to-diameter ratio.

### BACKGROUND

Composite materials are increasingly used in fields such as aerospace, shipbuilding, and automotive manufacturing due to their excellent properties, such as high specific strength and specific stiffness. In the above manufacturing fields, a thin-walled composite tubular component with a large length-to-diameter ratio is an important application of composite materials.

However, during the manufacturing and forming process of the thin-walled composite tubular component with the large length-to-diameter ratio, deformation tends to occur in the formed thin-walled components due to factors including errors between the actual mold surface and the theoretically designed profile, discrepancies between the actual ply thickness and the theoretical thickness during the filament laying process, and the inherent characteristics of composite materials. Therefore, it is necessary to control and compensate for the deformation during production. The accurate acquisition of the external and internal profile data of the tubular component by traceable digital measurement methods is a critical step in this process.

Nevertheless, for a tubular component with a curved profile, the internal space constraints prevent sensors from passing straight through the interior. Consequently, both traditional contact and non-contact measurement methods are limited by the accessibility of sensors, making it impossible to obtain the technical parameters of the internal profile.

Therefore, it is necessary to provide a method for measuring an inner profile of a thin-walled composite tubular component with a large length-to-diameter ratio, so as to solve the aforementioned technical problems.

### SUMMARY

One or more embodiments of the present disclosure provide a method for measuring an inner profile of a thin-walled composite tubular component with a large length-to-diameter ratio. The method includes: installing a contact probe, and calibrating a fixture coordinate system through the contact probe; acquiring an outer profile point cloud map of a tubular component to be inspected, wherein the outer profile point cloud map refers to a point cloud map under the fixture coordinate system; determining a discrete point regarding an outer profile of the tubular component to be inspected, acquiring probe coordinates of the discrete point, and measuring a thickness value of the discrete point; wherein the measuring a thickness value of the discrete point includes: selecting a plurality of inspection points at two ends of the tubular component to be inspected; measuring a thickness at each of the plurality of inspection points through a micrometer to acquire a standard thickness value d₁; measuring the thickness at the each of the plurality of inspection points through a thickness measuring device to be calibrated to acquire a measured thickness value d₂; calibrating the thickness measuring device to be calibrated by combining the standard thickness value d₁ and the measured thickness value d₂; measuring a thickness at the discrete point through the calibrated thickness measuring device to acquire a thickness value w of the discrete point; acquiring a normal vector of the discrete point according to the outer profile point cloud map, compensating the probe coordinates according to the normal vector, and acquiring outer profile coordinates of the discrete point; calculating inner profile coordinates corresponding to the discrete point according to the normal vector, the thickness value, and the outer profile coordinates of the discrete point; and selecting a plurality of discrete points, repeating, for each of the plurality of discrete points, the operations of the determining a discrete point regarding an outer profile of the tubular component to be inspected, acquiring the probe coordinates of the discrete point, and measuring a thickness value at the discrete point; and constructing an inner profile of the tubular component to be inspected based on inner profile coordinates of the plurality of discrete points.

In some embodiments, the calibrating a fixture coordinate system through the contact probe includes: installing the contact probe; installing the tubular component to be inspected on an inspection fixture, and acquiring the fixture coordinate system; selecting at least one geometric feature on the inspection fixture, and acquiring at least three reference coordinates of the at least one geometric feature under the fixture coordinate system; acquiring at least three measurement coordinates of the at least one geometric feature through the contact probe; and acquiring a first transformation relationship according to the at least three reference coordinates and the at least three measurement coordinates, and converting the at least three measurement coordinates according to the first transformation relationship.

In some embodiments, the acquiring an outer profile point cloud map of a tubular component to be inspected includes: establishing a scanner coordinate system; acquiring a second transformation relationship between the scanner coordinate system and the fixture coordinate system; scanning the tubular component to be inspected through a scanner to acquire relevant data of the tubular component to be inspected; and converting the relevant data into the outer profile point cloud map under the fixture coordinate system according to the second transformation relationship.

In some embodiments, the determining a discrete point regarding an outer profile of the tubular component to be inspected, acquiring probe coordinates of the discrete point includes: determining the plurality of discrete points; determining detection coordinates of the each of the plurality of discrete points through the contact probe; and for the each of the plurality of discrete points, converting the detection coordinates into the probe coordinates Pᵢ of the discrete point according to the first transformation relationship, wherein i denotes a number of the discrete point.

In some embodiments, the acquiring a normal vector of the discrete point according to the outer profile point cloud map, compensating the probe coordinates according to the normal vector, and acquiring outer profile coordinates of the discrete point includes: acquiring a probe radius R of the contact probe, and setting a screening threshold according to the probe radius R; acquiring, in the outer profile point cloud map, a point Qᵢ nearest to the discrete point in combination with the probe coordinate; acquiring a fitting point set according to the screening threshold, wherein a distance between each point in the fitting point set and the point Qᵢ is less than the screening threshold; constructing a fitted spatial surface based on the fitting point set; selecting a point on the fitted spatial surface that is nearest to the discrete point as an end point, wherein a line connecting the end point and the discrete point is the normal vector of the discrete point; and compensating the probe coordinates of the discrete point according to the normal vector to acquire the outer profile coordinates of the discrete point.

In some embodiments, a model expression equation of the fitted spatial surface is: z=k₁+k₂x+k₃y+k₄x²+k₅xy+k₆y²+k₇x³+k₉x²y+k₉y²x+k₁₀y³, wherein k₁~k₁₀ denote coefficients of terms of the model expression equation, and x, y, and z denote coordinate values of each point on the fitted spatial surface.

In some embodiments, the calculating inner profile coordinates corresponding to the discrete point according to the normal vector, the thickness value, and the outer profile coordinates of the discrete point includes: establishing a K-neighborhood of the discrete point, and acquiring a measured thickness set and a measured thickness value of m random sample points within the K-neighborhood; calculating a standard deviation of a sampling experiment of the random sample points according to the measured thickness set and the measured thickness value, the standard deviation satisfying

$$σ = \sqrt{\frac{1}{m - 1} {\sum }_{i = 1}^{m} {( {S}_{i} - \overline{S} )}^{2}} ,$$

where m denotes a count of the random sample points, Sᵢ denotes a calculated thickness value of an i-th random sample point, and S̅ denotes the measured thickness value; calculating a difference e between the thickness value w and the measured thickness value S̅, if |e|<3σ, using the measured thickness value as an actual thickness value of the discrete point, and if |e|≥3σ, reducing a radius of the K-neighborhood, and repeating the operations of establishing a K-neighborhood of the discrete point, and acquiring a measured thickness set and a measured thickness value of m random sample points within the K-neighborhood until |e|<3σ is satisfied; and correcting the outer profile coordinates according to the normal vector and the actual thickness value of the discrete point to acquire the inner profile coordinates of the discrete point.

In some embodiments, the acquiring a measured thickness set and a measured thickness value of m random sample points within the K-neighborhood includes: randomly determining the m random sample points within the K-neighborhood; selecting the i-th random sample point from the m random sample points as a detection point; measuring a thickness value at the i-th random sample point n times through the calibrated thickness measuring device to acquire n measured thickness values of the i-th random sample point; screening out distorted values from the n measured thickness values to obtain screened measured thickness values, and calculating the calculated thickness value of the i-th random sample point based on the screened measured thickness values; repeating the operations of selecting the i-th random sample point from the m random sample points as a detection point, until calculated thickness values of all the random sample points are acquired; and acquiring the measured thickness set and the measured thickness value according to the calculated thickness values of the random sample points.

In some embodiments, the calculated thickness value satisfies a formula

$${S}_{i} = \frac{{\sum }_{j = 1}^{n - l} {D}_{i , j}}{n - l} ,$$

where D_{i,j} denotes a measured thickness value obtained from a j-th measurement performed on a position of the i-th random sample point, and l denotes a count of the distorted values; and the measured thickness value is a mean value of values in the measured thickness set.

### BRIEF DESCRIPTION OF THE DRAWINGS

The present disclosure will be further described by way of exemplary embodiments. These exemplary embodiments will be described in detail with reference to the drawings. These embodiments are not limiting. In these embodiments, the same reference numerals denote the same structures, wherein:

FIG. 1 is a flowchart of a method for measuring an inner profile of a thin-walled composite tubular component with a large length-to-diameter ratio according to some embodiments of the present disclosure.

### DETAILED DESCRIPTION

The technical solutions in the embodiments of the present disclosure are clearly and completely described below with reference to the accompanying drawings in the embodiments of the present disclosure. It is apparent that the described embodiments are merely a part of the embodiments of the present disclosure, and not all of the embodiments. Based on the embodiments in the present disclosure, all other embodiments acquired by a person of ordinary skill in the art without creative efforts fall within the scope of protection of the present disclosure.

In addition, if descriptions involving “first,” “second,” or the like appear in the embodiments of the present disclosure, the descriptions of “first,” “second,” or the like are for descriptive purposes only and cannot be understood as indicating or implying relative importance or implicitly indicating a quantity of the indicated technical features. Thus, features defined with “first,” “second” may explicitly or implicitly include at least one of the features. In addition, the meaning of “and/or” appearing throughout the text includes three parallel solutions. Taking “a first transformation relationship and/or B” as an example, the meaning includes a solution of the first transformation relationship, or a solution of B, or a solution that satisfies both the first transformation relationship and B. In addition, the technical solutions of the various embodiments may be combined with each other, but the combination must be based on what can be achieved by a person of ordinary skill in the art. When the combination of technical solutions results in mutual contradiction or impossibility of implementation, the combination of such technical solutions should be considered non-existent and not within the scope of protection required by the present disclosure.

The embodiments of the present disclosure provide a method for measuring an inner profile of a thin-walled composite tubular component with a large length-to-diameter ratio (hereinafter referred to as a measurement method), which may be implemented by a processor.

The processor is configured to process a plurality of pieces of data during implementation of the measurement method. In some embodiments, the processor may include at least one of a microcontroller, a central processing unit, or the like. In some embodiments, the processor is communicatively connected to a plurality of devices (e.g., an automated device, a contact probe, a scanner, a thickness measuring device, etc.) for implementing the measurement method, thereby achieving data transmission.

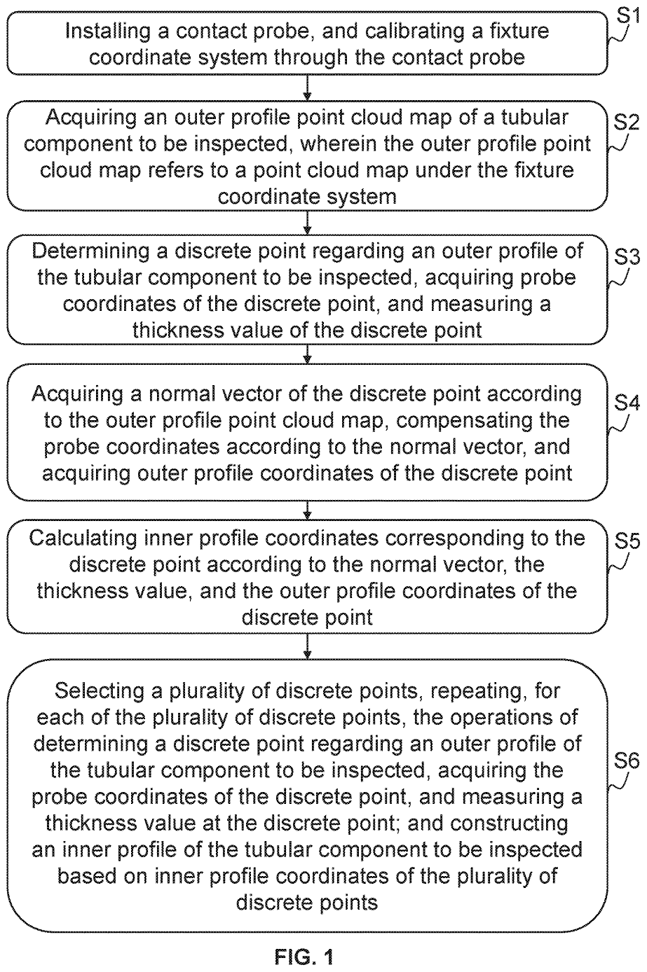

FIG. 1 is a flowchart of a method for measuring an inner profile of a thin-walled composite tubular component with a large length-to-diameter ratio according to some embodiments of the present disclosure.

In some embodiments, as shown in FIG. 1, the measurement method includes the following operations.

In S1, a contact probe is installed, and a fixture coordinate system is calibrated through the contact probe.

In some embodiments, the operation S1 includes the following operations S11 to S15.

In S11, the contact probe is installed.

The contact probe is a measurement tool for acquiring geometric information of a surface of an object through physical contact. In some embodiments, the contact probe may be a joint arm, a T-Probe of a Leica tracker, a coordinate measuring machine, or the like. In some embodiments, the automated device (e.g., an industrial robot, etc.) may install the contact probe at a preset position (e.g., a position near an inspection fixture). In some embodiments, the contact probe may establish its own coordinate system after power-on, and the processor may read three-dimensional coordinates of a current position of the contact probe in its own coordinate system.

In S12, the tubular component to be inspected is installed on the inspection fixture, and the fixture coordinate system is acquired.

The tubular component to be inspected refers to a pipeline workpiece that requires quality inspection. The inspection fixture refers to a device (e.g., a workbench, a bracket, etc.) for fixing, positioning, and supporting the tubular component to be inspected. The fixture coordinate system is a reference coordinate system during the operation of the inspection fixture.

In some embodiments, the processor may select the inspection fixture adapted to the tubular component to be inspected, control the automated device to install the tubular component to be inspected on the inspection fixture, and use a coordinate system of the inspection fixture as the fixture coordinate system.

In S13, at least one geometric feature on the inspection fixture is selected, and at least three reference coordinates of the at least one geometric feature are acquired under the fixture coordinate system.

The geometric feature refers to a structural feature on the inspection fixture that can be recognized and located by the contact probe. In some embodiments, the geometric feature may include a structure that is easy to detect and has high positioning accuracy, such as a plane, a straight line, a positioning hole, or the like. The reference coordinates refer to three-dimensional coordinates of a certain structure of the geometric feature (e.g., a center or a boundary of the positioning hole, a point on the plane or the straight line, etc.) under the fixture coordinate system.

In some embodiments, the processor may select the at least one geometric feature on the inspection fixture, select at least three non-collinear points in the at least one geometric feature, and use three-dimensional coordinates of the at least three non-collinear points as the at least three reference coordinates of the at least one geometric feature.

In S14, at least three measurement coordinates of the at least one geometric feature are acquired through the contact probe.

The measurement coordinates refer to three-dimensional coordinates read by the contact probe in its own coordinate system. In some embodiments, after the at least one geometric feature is determined, the processor may control the contact probe to measure the at least three measurement coordinates of the selected at least one geometric feature.

In S15, a first transformation relationship is acquired according to the at least three reference coordinates and the at least three measurement coordinates, and the at least three measurement coordinates are converted according to the first transformation relationship.

The first transformation relationship is configured to convert the fixture coordinate system and the intrinsic coordinate system of the contact probe. In some embodiments, the at least three reference coordinates measured under the fixture coordinate system and the at least three measurement coordinates measured under the intrinsic coordinate system of the contact probe have a corresponding relationship for the at least one geometric feature. The first transformation relationship may be acquired based on the at least three reference coordinates and the at least three measurement coordinates. The three-dimensional coordinates located in the intrinsic coordinate system of the contact probe may be converted into the fixture coordinate system based on the first transformation relationship, thereby completing the calibration of the fixture coordinate system.

In S2, an outer profile point cloud map of the tubular component to be inspected is acquired. The outer profile point cloud map refers to a point cloud map under the fixture coordinate system.

In some embodiments, the operation S2 includes the following operations S21 to S24.

In S21, a scanner coordinate system is established.

The scanner coordinate system refers to a reference coordinate system used by a scanner when acquiring the outer profile point cloud map of the tubular component to be inspected. In some embodiments, the processor may use an intrinsic coordinate system of the scanner as the scanner coordinate system.

The scanner is configured to acquire the outer profile point cloud map of the tubular component to be inspected. In some embodiments, the scanner may include at least one of a laser three-dimensional measurement scanner, a structured light three-dimensional scanner, or the like.

In S22, a second transformation relationship between the scanner coordinate system and the fixture coordinate system is acquired.

The second transformation relationship is configured to convert the fixture coordinate system and the scanner coordinate system. In some embodiments, the manner for acquiring the second transformation relationship is similar to the manner for acquiring the first transformation relationship in the operation S15. That is, the second transformation relationship is acquired based on a three-dimensional coordinate conversion of at least three non-collinear feature points in the fixture coordinate system and the scanner coordinate system.

In S23, the tubular component to be inspected is scanned through the scanner to acquire relevant data of the tubular component to be inspected.

The relevant data refers to raw data recorded by the scanner when scanning an outer profile of the tubular component to be inspected. The outer profile refers to an outer surface of the tubular component to be inspected. In some embodiments, the processor may scan the outer profile of the tubular component to be inspected through the installed scanner to acquire the relevant data under the scanner coordinate system.

In S24, the relevant data is converted into the outer profile point cloud map under the fixture coordinate system according to the second transformation relationship.

Outer profile point cloud data refers to three-dimensional coordinates of a point on the outer profile of the tubular component to be inspected under the fixture coordinate system. In some embodiments, the processor may convert the relevant data into the outer profile point cloud data under the fixture coordinate system, and merge a plurality of pieces of outer profile point cloud data into the outer profile point cloud map under the fixture coordinate system.

Since the contact probe, the inspection fixture, and the scanner are three mutually independent devices, and each of the contact probe, the inspection fixture, and the scanner has a mutually independent coordinate system, three-dimensional coordinates acquired by the contact probe and the scanner can be unified into the fixture coordinate system through the operation S1 and the operation S2, which provides a unified platform for subsequent data calculation, and is beneficial for improving the calculation efficiency and calculation accuracy.

In S3, a discrete point regarding an outer profile of the tubular component to be inspected is determined, probe coordinates of the discrete point are acquired, and a thickness value of the discrete point is measured.

In some embodiments, the operation S3 includes the following operations S31 to S38.

In S31, the plurality of discrete points are determined.

The plurality of discrete points refer to measurement points selected on the outer profile of the tubular component to be inspected. In some embodiments, the processor may divide the tubular component to be inspected into a plurality of cross-sections along a direction perpendicular to a center line of the tubular component to be inspected at a preset length (e.g., 100 mm to 150 mm). On each cross-section, a plurality of discrete points located on the outer profile are selected at a preset interval (e.g., 50 mm to 150 mm).

In some embodiments, when the change in cross-sectional curvature is greater than its average value, a first preset interval (e.g., 50 mm) is selected to screen the plurality of discrete points. When the change in cross-sectional curvature is less than its average value, a second preset interval (e.g., 150 mm) is selected to screen the plurality of discrete points.

In S32, detection coordinates of the each of the plurality of discrete points are determined through the contact probe.

The detection coordinates refer to three-dimensional coordinates read when the contact probe touches the plurality of discrete points on the outer profile of the tubular component to be inspected. In some embodiments, after the plurality of discrete points are selected, the contact probe may measure the detection coordinates of the plurality of discrete points. It should be noted that the detection coordinates are three-dimensional coordinates under the intrinsic coordinate system of the contact probe.

In S33, for the each of the plurality of discrete points, the detection coordinates are converted into the probe coordinates Pᵢ of the discrete point according to the first transformation relationship, wherein i denotes a number of the discrete point.

The probe coordinates refer to three-dimensional coordinates of the discrete point under the fixture coordinate system. In some embodiments, the processor may convert the detection coordinates according to the first transformation relationship acquired in the operation S15, to acquire the probe coordinates Pᵢ of the discrete point under the fixture coordinate system.

In S34, a plurality of inspection points are selected at two ends of the tubular component to be inspected.

The plurality of inspection points refer to thickness measurement points selected at the two ends of the tubular component to be inspected. In some embodiments, the processor may randomly select the plurality of inspection points in areas at the two ends of the tubular component to be inspected, where direct detection by a micrometer is possible.

In S35, a thickness at each of the plurality of inspection points is measured through a micrometer to acquire a standard thickness value d₁.

The standard thickness value is the thickness data measured at each of the plurality of inspection points. In some embodiments, the processor may use the thickness of each of the plurality of inspection points measured by the micrometer as the standard thickness value d₁ of each of the plurality of inspection points.

In S36, the thickness at each of the plurality of inspection points is measured through a thickness measuring device to be calibrated to acquire a measured thickness value d₂.

The measured thickness value refers to raw data read by the thickness measuring device to be calibrated at each of the plurality of inspection points. The thickness measuring device is configured to measure the thickness of the tubular component to be inspected. For example, the thickness measuring device may include a laser thickness gauge, an ultrasonic thickness gauge, or the like. In some embodiments, the processor may use the raw data read by the thickness measuring device to be calibrated at each of the plurality of inspection points as the measured thickness value of each of the plurality of inspection points.

In S37, the thickness measuring device to be calibrated is calibrated by combining the standard thickness value d₁ and the measured thickness value d₂.

In some embodiments, the processor may pair the standard thickness value d₁ and the measured thickness value d₂ of the each of the plurality of inspection points to form a data pair; fit a calibration model (e.g., a linear model, or the like) based on a plurality of data pairs, and solve a correction coefficient to achieve the calibration of the thickness measuring device to be calibrated.

In S38, a thickness at the discrete point is measured through a calibrated thickness measuring device to acquire a thickness value w of the discrete point.

In some embodiments, the processor may control the calibrated thickness measuring device to perform N measurements of thickness values at a discrete point; take thickness values exceeding a detection error range as distorted data and remove them; and determine a mean value of remaining thickness values as the thickness value w of the discrete point. The value N and the value of the detection error range are preset based on actual conditions.

The above procedure can calibrate the thickness measuring device to ensure the detection accuracy of the thickness measuring device, thereby improving the accuracy of the thickness value of the discrete point.

In S4, a normal vector of the discrete point is acquired according to the outer profile point cloud map, the probe coordinates are compensated according to the normal vector, and outer profile coordinates of the discrete point are acquired.

In some embodiments, the operation S4 includes the following operations S41 to S46.

In S41, a probe radius R of the contact probe is acquired, and a screening threshold is set according to the probe radius R.

The probe radius refers to a geometric radius of a spherical tip at the end of the contact probe. In some embodiments, after selecting the contact probe, the processor may consult technical parameters of the contact probe to acquire the probe radius R.

The screening threshold refers to a distance limit used for screening a fitting point set from the plurality of pieces of outer profile point cloud data. In some embodiments, the processor may set the screening threshold according to the probe radius R. For example, the screening threshold is set to 3R.

In S42, in the outer profile point cloud map, a point Qᵢ nearest to the discrete point is acquired in combination with the probe coordinate.

In some embodiments, the processor may retrieve the outer profile point cloud map acquired in the operation S24 and the probe coordinates of the discrete point acquired in the operation S33; and search for the point Qᵢ closest to the discrete point (i.e., determine a position of the discrete point on the outer profile point cloud map). It should be noted that a distance value here may be a Euclidean distance.

In S43, the fitting point set is acquired according to the screening threshold. A distance between each point in the fitting point set and the point Qᵢ is less than the screening threshold.

The fitting point set refers to a subset formed by outer profile point cloud data screened from the outer profile point cloud map for constructing a local surface. In some embodiments, the processor may establish a spherical space with the point Qᵢ as a center and the screening threshold as a radius; extract all outer profile point cloud data located within the spherical space from the outer profile point cloud map; and collect the outer profile point cloud data into a set. The set is the fitting point set.

In S44, a fitted spatial surface is constructed based on the fitting point set.

The fitted spatial surface refers to a fitted mathematical surface model of a local outer profile of the tubular component to be inspected. In some embodiments, a model expression equation of the fitted spatial surface is:

$$z = {k}_{1} + {k}_{2} x + {k}_{3} y + {k}_{4} {x}^{2} + {k}_{5} xy + {k}_{6} {y}^{2} + {k}_{7} {x}^{3} + {k}_{8} {x}^{2} y + {k}_{9} {y}^{2} x + {k}_{10} {y}^{3} , \qquad ( 1 )$$

where k₁~k₁₀ denote coefficients of terms of the model expression equation, and x, y, and z denote coordinate values of each point on the fitted spatial surface.

In some embodiments, k₁~k₁₀ may be a system default value, an empirical value, a manually preset value, etc., or any combination thereof. x, y, and z are determined based on the fitting point set.

In S45, selecting a point on the fitted spatial surface that is nearest to the discrete point as an end point, wherein a line connecting the end point and the discrete point is the normal vector of the discrete point.

The normal vector refers to a unit vector perpendicular to a tangent plane at a discrete point on the outer profile of the tubular component to be inspected. In some embodiments, the processor may use the point on the fitted spatial surface with a smallest Euclidean distance to the discrete point as the end point; use the direction of a line connecting the discrete point and the end point as a direction of the normal vector at the discrete point; and set a magnitude of the normal vector to 1 to acquire the normal vector.

In S46, the probe coordinates of the discrete point are compensated according to the normal vector to acquire the outer profile coordinates of the discrete point.

The outer profile coordinates refer to three-dimensional coordinates acquired by compensating for the probe coordinate. In some embodiments, the processor may subtract the probe radius from the probe coordinates along the direction of the normal vector of the discrete point to acquire the compensated outer profile coordinates of the discrete point. Merely by way of example, an expression equation of the outer profile coordinates satisfies the following equation.

$${Q}_{i}^{′} = {Q}_{i} - \vec{e} R , \qquad ( 2 )$$

where

$${Q}_{i}^{′}$$

denotes the outer profile coordinate, Qᵢ denotes probe coordinates corresponding to a discrete point to be compensated, and \vec{e} denotes a normal vector of the discrete point to be compensated.

The above calculation can remove the influence of the probe radius on the coordinate calculation of the discrete point, thereby improving the detection precision.

In S5, calculating inner profile coordinates corresponding to the discrete point according to the normal vector, the thickness value, and the outer profile coordinates of the discrete point.

In some embodiments, the operation S5 includes the following operations S51 to S54.

In S51, a K-neighborhood of the discrete point is established, and a measured thickness set and a measured thickness value of m random sample points are acquired within the K-neighborhood.

The K-neighborhood represents a set composed of k points in the outer profile point cloud map whose Euclidean distance to the discrete point is not greater than a neighborhood radius, and k represents a count of points. In some embodiments, the value of m is determined based on actual demands. The neighborhood radius is preset based on experience. For example, the neighborhood radius may be three times as much as the probe radius.

In some embodiments, the operation S51 includes the following operations S511 to S516.

In S511, the m random sample points are randomly determined within the K-neighborhood.

In S512, the i-th random sample point is selected from the m random sample points as a detection point, wherein i=1, 2, . . . , m (m≤k).

In S513, a thickness value at the i-th random sample point is measured n times through the calibrated thickness measuring device to acquire n measured thickness values of the i-th random sample point.

The measured thickness value refers to a thickness value measured by the calibrated thickness measuring device. In some embodiments, the value of n is determined based on actual demands.

In S514, distorted values are screened out from the n measured thickness values, and the calculated thickness value of the i-th random sample point is calculated based on the screened measured thickness values.

The distorted value refers to a measured thickness value exceeding an allowable error. In some embodiments, the processor may determine measured thickness values outside [a−c, a+c] as the distorted values based on a distortion determination parameter c; screen out the distorted values; and retain measured thickness values within [a−c, a+c]. The value of the distortion determination parameter is determined by a person skilled in the art based on actual conditions, and a may be a mean value or a median of the n measured thickness values of the i-th random sample point.

The calculated thickness value refers to a thickness value acquired by calculation after screening out the distorted values. In some embodiments, the processor may determine the calculated thickness value based on the retained measured thickness values. Merely by way of example, the calculated thickness value satisfies the following formula.

$${S}_{i} = \frac{{\sum }_{j = 1}^{n - l} {D}_{i , j}}{n - l} , \qquad ( 3 )$$

where D_{i,j} denotes the measured thickness value obtained from a j-th measurement performed on a position of the i-th random sample point, and l denotes a count of the distorted values.

In S515, the operations of selecting the i-th random sample point from the m random sample points as the detection point are repeated until the calculated thickness values of all the random sample points are acquired. It is worth noting that the i-th random sample point selected in each round for acquiring the calculated thickness value is different. For example, a first round selects a first (i.e., i=1) random sample point, and a second round selects any random sample point among 2 to m.

In S516, the measured thickness set and the measured thickness value are acquired according to the calculated thickness values of the random sample points.

The measured thickness set refers to a set composed of calculated thickness values of a plurality of random sample points. In some embodiments, the processor may acquire the calculated thickness value of each of the m random sample points through the above operations, and form a measured thickness set {S₁, S₂, . . . , Sₘ}.

The measured thickness value is a mean value of the values in the measured thickness set. In some embodiments, the processor may calculate a mean value of a plurality of calculated thickness values in the measured thickness set, and use the mean value as the measured thickness value, i.e., S⁻=(S₁+S₂+ . . . +Sₘ)/m.

In S52, a standard deviation of a sampling experiment of the random sample points is calculated according to the measured thickness set and the measured thickness value. Merely by way of example, the standard deviation satisfies the following formula.

$$σ = \sqrt{\frac{1}{m - 1} {\sum }_{i = 1}^{m} {( {S}_{i} - \overline{S} )}^{2}} , \qquad ( 4 )$$

where m denotes a count of the random sample points, Sᵢ denotes a calculated thickness value of an i-th random sample point, and S denotes the measured thickness value.

The standard deviation is used to evaluate the dispersion degree of the calculated measurement values of the plurality of random sample points within the K-neighborhood. In some embodiments, the processor may substitute the measured thickness set {S₁, S₂, . . . , Sₘ} and the measured thickness value S̅ acquired in the operation S516 into the above formula (4) to calculate the standard deviation.

In S53, a difference e between the thickness value w and the measured thickness value S is calculated, if |e|<3σ, the measured thickness value is used as an actual thickness value of the discrete point, and if |e|≥3σ, a radius of the K-neighborhood is reduced, and the operations of establishing the K-neighborhood of the discrete point, and acquiring the measured thickness set and the measured thickness value of the m random sample points within the K-neighborhood are repeated until |e|<3σ is satisfied.

In some embodiments, the processor may retrieve the thickness value w of the discrete point acquired in the operation S38 and the measured thickness value S̅ acquired in the operation S516 according to the number of the discrete point, calculate the difference e between the thickness value w and the measured thickness value S̅; and retrieve the standard deviation calculated in the operation S53. If |e|<3σ, the processor determines the measured thickness value as the actual thickness value of the discrete point. If |e|≥3σ, the processor reduces the neighborhood radius of the K-neighborhood, repeats the operation of establishing the K-neighborhood of the discrete point, and calculates the measured thickness set, the measured thickness value, the standard deviation, etc., within the K-neighborhood until |e|<3σ is satisfied.

It should be noted that a reduced neighborhood radius is set to be half of the original neighborhood radius, or other ratios may be set to determine the reduced neighborhood radius.

In S54, the outer profile coordinates are corrected according to the normal vector and the actual thickness value of the discrete point to acquire the inner profile coordinates of the discrete point.

The inner profile refers to an inner surface of the tubular component to be inspected. The inner profile coordinates refer to three-dimensional coordinates of a point on the inner profile of the tubular component to be inspected, calculated based on the outer profile coordinate, the normal vector, and the actual thickness value. In some embodiments, the processor may calculate the inner profile coordinates according to the following expression based on the outer profile discrete point

$${Q}_{i}^{′}$$

and the normal vector \vec{e} of the discrete point calculated in the operation S46, and the actual thickness value of the each of the discrete point calculated in the operation S53.

$${P}_{i} = {Q}_{i}^{′} - \overline{s} \cdot \vec{e} , \qquad ( 5 )$$

where Pᵢ denotes inner profile coordinates corresponding to the i-th outer profile discrete point.

In S6, a plurality of discrete points are selected, for each of the plurality of discrete points, the operations of the determining a discrete point regarding an outer profile of the tubular component to be inspected, acquiring probe coordinates of the discrete point, and measuring a thickness value of the discrete point are repeated. The inner profile of the tubular component to be inspected is constructed based on inner profile coordinates of the plurality of discrete points.

The present disclosure determines that the inner profile of the tubular component has the same shape as the outer profile of the tubular component based on an equal-thickness principle, i.e., when a quality defect (e.g., bending) occurs at a location of the outer profile, a corresponding inner profile defect also occurs at the inner profile. Combined with the thickness parameter, the normal vector, and the outer profile point cloud map of the tubular component acquired by scanning, a large count of inner profile structural points can be quickly acquired by offsetting, and then the inner profile of the tubular component can be quickly constructed based on the structural points and overall curve changes of the outer profile.

The outer profile point cloud map can be quickly acquired by the scanner or other non-contact devices, which is beneficial for improving the construction efficiency. Furthermore, compared to the inner profile, which is occluded, the acquisition of the outer profile is not occluded, which minimizes difficulty in implementing the measurement method, is beneficial for improving work efficiency, and the reduction of occlusions is also beneficial for improving the inspection accuracy.

Meanwhile, inspection by contact measurement tools, such as the contact probe, can acquire a large number of inspection parameters in measurable areas, ensuring the accuracy of thickness parameters.

Furthermore, the present disclosure acquires parameters such as thickness through contact measurement, which are difficult to accurately acquire by non-contact measurement, while parameters with lower requirements, such as outer profile curve changes of the tubular component, are acquired through non-contact measurement; simultaneously, the inner profile which is difficult to measure is converted into the outer profile which is easy to measure, based on the equal-thickness principle, thereby achieving the accurate construction of the inner profile.

Meanwhile, the present disclosure combines the advantages of contact measurement and non-contact measurement, improving the inspection efficiency and reducing the inspection difficulty as much as possible while ensuring the inspection accuracy.

The above are merely preferred embodiments of the present disclosure and are not intended to limit the patent scope of the present disclosure. Any equivalent structure or equivalent process transformation made based on the content of the present disclosure and the accompanying drawings, or any direct or indirect application in other related technical fields shall be similarly included within the patent protection scope of the present disclosure.

What is claimed is:

1. A method for measuring an inner profile of a thin-walled composite tubular component with a large length-to-diameter ratio, comprising:
installing a contact probe, and calibrating a fixture coordinate system through the contact probe;
acquiring an outer profile point cloud map of a tubular component to be inspected, wherein the outer profile point cloud map refers to a point cloud map under the fixture coordinate system;
determining a discrete point regarding an outer profile of the tubular component to be inspected, acquiring probe coordinates of the discrete point, and measuring a thickness value of the discrete point;
wherein the measuring a thickness value of the discrete point includes:
selecting a plurality of inspection points at two ends of the tubular component to be inspected;
measuring a thickness at each of the plurality of inspection points through a micrometer to acquire a standard thickness value d₁;
measuring the thickness at the each of the plurality of inspection points through a thickness measuring device to be calibrated to acquire a measured thickness value d₂;
calibrating the thickness measuring device to be calibrated by combining the standard thickness value d₁ and the measured thickness value d₂; and
measuring a thickness at the discrete point through the calibrated thickness measuring device to acquire a thickness value w of the discrete point;
acquiring a normal vector of the discrete point according to the outer profile point cloud map, compensating the probe coordinates according to the normal vector, and acquiring outer profile coordinates of the discrete point;
calculating inner profile coordinates corresponding to the discrete point according to the normal vector, the thickness value, and the outer profile coordinates of the discrete point;
selecting a plurality of discrete points, repeating, for each of the plurality of discrete points, the operations of the determining a discrete point regarding an outer profile of the tubular component to be inspected, acquiring probe coordinates of the discrete point, and measuring a thickness value at the discrete point; and
constructing an inner profile of the tubular component to be inspected based on inner profile coordinates of the plurality of discrete points.

2. The method according to claim 1, wherein the calibrating a fixture coordinate system through the contact probe includes:
installing the contact probe;
installing the tubular component to be inspected on an inspection fixture, and acquiring the fixture coordinate system;
selecting at least one geometric feature on the inspection fixture, and acquiring at least three reference coordinates of the at least one geometric feature under the fixture coordinate system;
acquiring at least three measurement coordinates of the at least one geometric feature through the contact probe; and
acquiring a first transformation relationship according to the at least three reference coordinates and the at least three measurement coordinates, and converting the at least three measurement coordinates according to the first transformation relationship.

3. The method according to claim 1, wherein the acquiring an outer profile point cloud map of a tubular component to be inspected includes:
establishing a scanner coordinate system;
acquiring a second transformation relationship between the scanner coordinate system and the fixture coordinate system;
scanning the tubular component to be inspected through a scanner to acquire relevant data of the tubular component to be inspected; and
converting the relevant data into the outer profile point cloud map under the fixture coordinate system according to the second transformation relationship.

4. The method according to claim 2, wherein the determining a discrete point regarding an outer profile of the tubular component to be inspected, acquiring probe coordinates of the discrete point includes:
determining the plurality of discrete points;
determining detection coordinates of the each of the plurality of discrete points through the contact probe; and
for the each of the plurality of discrete points, converting the detection coordinates into the probe coordinates Pᵢ of the discrete point according to the first transformation relationship, wherein i denotes a number of the discrete point.

5. The method according to claim 1, wherein the acquiring a normal vector of the discrete point according to the outer profile point cloud map, compensating the probe coordinates according to the normal vector, and acquiring outer profile coordinates of the discrete point includes:
acquiring a probe radius R of the contact probe, and setting a screening threshold according to the probe radius R;
acquiring, in the outer profile point cloud map, a point Qᵢ nearest to the discrete point in combination with the probe coordinates;
acquiring a fitting point set according to the screening threshold, wherein a distance between each point in the fitting point set and the point Qᵢ is less than the screening threshold;
constructing a fitted spatial surface based on the fitting point set;
selecting a point on the fitted spatial surface that is nearest to the discrete point as an end point, wherein a line connecting the end point and the discrete point is the normal vector of the discrete point; and
compensating the probe coordinates of the discrete point according to the normal vector to acquire the outer profile coordinates of the discrete point.

6. The method according to claim 5, wherein a model expression equation of the fitted spatial surface is:
$$z = {k}_{1} + {k}_{2} x + {k}_{3} y + {k}_{4} {x}^{2} + {k}_{5} xy + {k}_{6} {y}^{2} + {k}_{7} {x}^{3} + {k}_{8} {x}^{2} y + {k}_{9} {y}^{2} x + {k}_{10} {y}^{3} ,$$
wherein k₁~k₁₀ denote coefficients of terms of the model expression equation, and x, y, and z denote coordinate values of each point on the fitted spatial surface.

7. The method according to claim 1, wherein the calculating inner profile coordinates corresponding to the discrete point according to the normal vector, the thickness value, and the outer profile coordinates of the discrete point includes:
establishing a K-neighborhood of the discrete point, and acquiring a measured thickness set and a measured thickness value of m random sample points within the K-neighborhood;
calculating a standard deviation of a sampling experiment of the random sample points according to the measured thickness set and the measured thickness value, the standard deviation satisfying
$$σ = \sqrt{\frac{1}{m - 1} {\sum }_{i = 1}^{m} {( {S}_{i} - \overline{S} )}^{2}} ,$$
where m denotes a count of the random sample points, Sᵢ denotes a calculated thickness value of an i-th random sample point, and S denotes the measured thickness value;
calculating a difference e between the thickness value w and the measured thickness value S, if |e|<3σ, using the measured thickness value as an actual thickness value of the discrete point, and if |e|≥3σ, reducing a radius of the K-neighborhood, and repeating the operations of establishing a K-neighborhood of the discrete point, and acquiring a measured thickness set and a measured thickness value of m random sample points within the K-neighborhood until |e|<3σ is satisfied; and
correcting the outer profile coordinates according to the normal vector and the actual thickness value of the discrete point to acquire the inner profile coordinates of the discrete point.

8. The method according to claim 7, wherein the acquiring a measured thickness set and a measured thickness value of m random sample points within the K-neighborhood includes:
randomly determining the m random sample points within the K-neighborhood;
selecting the i-th random sample point from the m random sample points as a detection point;
measuring a thickness value at the i-th random sample point n times through the calibrated thickness measuring device to acquire n measured thickness values of the i-th random sample point;
screening out distorted values from the n measured thickness values to obtain screened measured thickness values, and calculating the calculated thickness value of the i-th random sample point based on the screened measured thickness values;
repeating the operations of selecting the i-th random sample point from the m random sample points as a detection point, until calculated thickness values of all the random sample points are acquired; and
acquiring the measured thickness set and the measured thickness value according to the calculated thickness values of the random sample points.

9. The method according to claim 8, wherein the calculated thickness value satisfies a formula
$${S}_{i} = \frac{{\sum }_{j = 1}^{n - l} {D}_{i , j}}{n - l} ,$$
where D_{i,j} denotes a measured thickness value obtained from a j-th measurement performed on a position of the i-th random sample point, and l denotes a count of the distorted values; and the measured thickness value is a mean value of values in the measured thickness set.
